(19) United States
(12) Patent Application Publication
(10) Pub. No.: US 2023/0225551 A1
(43) Pub. Date: Jul. 20, 2023

(54) VIDEO DISPLAY DEVICE AND CONTROL METHOD THEREFOR

(71) Applicant: Samsung Electronics Co., Ltd., Suwon-si (KR)

(72) Inventors: Yonghun CHOI, Suwon-si (KR); Jiyoung WOO, Suwon-si (KR); Youngsun SHIN, Suwon-si (KR)

(21) Appl. No.: 18/186,071

(22) Filed: Mar. 17, 2023

Related U.S. Application Data
(63) Continuation of application No. PCT/KR2021/009381, filed on Jul. 21, 2021.

(30) Foreign Application Priority Data
Sep. 18, 2020 (KR) 10-2020-0120328

(51) Int. Cl. A47J 36/32; G06V 20/68; H04N 9/31; G01G 19/414

(52) U.S. Cl. CPC A47J 36/321; G06V 20/68; H04N 9/3179; G01G 19/4146; G06F 3/017

(57) ABSTRACT

An image display device according to disclosed one aspect comprises: a plate for detecting the weight of food ingredients; a projector for projecting images onto the plate; a camera for capturing food ingredients and user inputs relative to the images projected; and a controller for controlling the projector so that the changed images are outputted in response to the user inputs or changes in weight of the food ingredients.

### CROSS-REFERENCE TO RELATED APPLICATIONS

This application is a Bypass Continuation of International Application No. PCT/KR2021/009381, filed Jul. 21, 2021, which claims priority to Korean Patent Application No. 10-2020-0120328, filed Sep. 18, 2020, the disclosures of which are herein incorporated by reference in their entirety.

### BACKGROUND

### 1. Field

The disclosure relates to a video display device and control method therefor. Specifically, the disclosure relates to a video display device for providing cooking information for the user through a projector and a plate.

### 2. Description of Related Art

Users commonly cook food with various cooking tools and home appliances based on the users' experiences and intuitions.

Such a common method is, however, sometimes inconvenient because food ingredients are measured inaccurately and an extra recipe needs to be searched for.

Hence, a technique is required for a user to obtain cooking information and control various home appliances required for cooking in a single device.

### SUMMARY

The disclosure provides a virtual cooking environment for the user to experience convenience in the kitchen. The disclosure also provides an integrated platform connected with various home appliances to control a home appliance required for cooking.

According to an aspect of the disclosure, a video display device includes a plate configured to detect a weight of a food ingredient; a projector configured to project an image onto the plate; a camera configured to capture an input of a user relative to the image projected, and the food ingredient; and a controller configured to change the image and control the projector to project the image changed, in response to a weight change of the food ingredient or the input of the user.

The controller may control a main body to recognize the food ingredient located on the plate through the camera and output cooking information regarding the food ingredient in the image.

The controller may control the main body to output cooking information including weight information of the food ingredient, calorie information of the food ingredient, a cooking list using the food ingredient and information about a recommended amount of the food ingredient in the image.

The controller may control the main body to output a recipe based on a plurality of food ingredients in the image in response to recognition of the plurality of food ingredients on a surface of the plate.

The controller may control a cutting line to be displayed on the food ingredient located on the plate, wherein the cutting line is generated based on at least one of weight information, calorie information or information about a recommended amount of the food ingredient.

The video display device may further include a communicator configured to communicate with at least one of a server or a home appliance.

The communicator may control the communicator to transmit a cooking command to the home appliance in response to detection of a user input about the cooking command.

The communicator may control the communicator to transmit a cooking value based on a recipe to the home appliance in response to detection of a user input selecting the recipe based on the food ingredient.

The communicator may control the home appliance to update a list registered in the home appliance with a portion of the food ingredient in response to separation of the food ingredient from the plate, and the home appliance may be a refrigerator.

The controller may control the main body to output a message confirming or rejecting the updating in the image based on the separation of the food ingredient from the plate.

The controller may control the main body to output a plurality of zones in which different cooking is performed in the image, and control the communicator to receive an input of the user determining a cooking value for each of the plurality of zones, and transmit the cooking value to the home appliance, and the home appliance may be an oven capable of multi-zone cooking.

The controller may control the main body to output a recipe for each stage of cooking which mixes a plurality of food ingredients in the image, output a weight of a first food ingredient in real time based on input of the first food ingredient to a container for performing the cooking among the plurality of food ingredients, and output a message based on completion of the inputting of the first food ingredient. The message is output visually for display or output as sound.

The controller may initialize an output weight in response to completion of the inputting of the first food ingredient.

The controller may update a required amount of a second food ingredient to maintain a ratio of the second food ingredient to the first food ingredient set in the recipe in response to the input amount of the first food ingredient exceeding a required amount.

The video display device may further include a communicator configured to communicate with at least one of a server or a home appliance, the controller may transmit the required amount of the second food ingredient corresponding to the ratio of the second food ingredient to the first food ingredient set in the recipe to the home appliance in response to completion of inputting of the first food ingredient, and the home appliance may include a water purifier or an aerated water maker.

According to an aspect of the disclosure, a method of controlling a video display device including a projector and a plate includes detecting a weight of a food ingredient; projecting an image onto the plate; capturing the food ingredient and an input of a user about the image; and controlling the projector to output an image changed in response to a weight change of the food ingredient or the input of the user.

The method of controlling the video display device may further include transmitting a cooking value based on a recipe to a home appliance in response to detection of a user input selecting the recipe based on the food ingredient.

The method of controlling the video display device may further include controlling the home appliance to update a list registered in the home appliance connected to a main body with a portion of the food ingredient in response to separation of the food ingredient from the plate.

The method of controlling the video display device may further include controlling the main body to output a recipe for each state of cooking which mixes a plurality of food ingredients in the image, outputting a weight of a first food ingredient in real time based on inputting of the first food ingredient to a container for performing the cooking among the plurality of food ingredients, and outputting a message in sound or display in response to an input amount of the first food ingredient reaching a required amount, and updating a required amount of a second food ingredient to maintain a ratio of the second food ingredient to the first food ingredient set in the recipe in response to the input amount of the first food ingredient exceeding the required amount.

According to an aspect of the disclosure, a computer program coupled to a computing device is stored in a recording medium to carry out operations of detecting a weight of a food ingredient; projecting an image onto the plate; capturing the food ingredient and an input of a user about the image; and controlling the projector to output an image changed in response to a weight change of the food ingredient or the input of the user

According to the disclosure, a virtual cooking environment may be provided to give convenience in the kitchen. Furthermore, connection is made with various home appliances to control a home appliance required for cooking.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates system in which a video display device is implemented, according to an embodiment of the disclosure.

FIG. 2 illustrates a video display device, according to an embodiment of the disclosure.

FIG. 3 illustrates a method of controlling a video display device, according to an embodiment of the disclosure.

FIG. 4 illustrates an image output by a video display device based on a food ingredient placed on a plate, according to an embodiment.

FIG. 5 illustrates an image output by a video display device based on a plurality of food ingredients placed on a plate, according to an embodiment.

FIG. 6 illustrates an image with cutting lines created by a video display device on a food ingredient placed on a plate, according to an embodiment.

FIG. 7 illustrates a control sequence chart between a video display device and a home appliance, according to an embodiment.

FIG. 8 illustrates multi-zone cooking control of a video display device, according to an embodiment.

FIG. 9 illustrates a control sequence chart between a video display device and a home appliance, according to an embodiment.

FIG. 10 illustrates a control sequence chart between a video display device and a home appliance, according to another embodiment.

FIGS. 11, 12, and 13 illustrate examples of images projected onto a plate according to the control sequence chart of FIG. 10.

### DETAILED DESCRIPTION

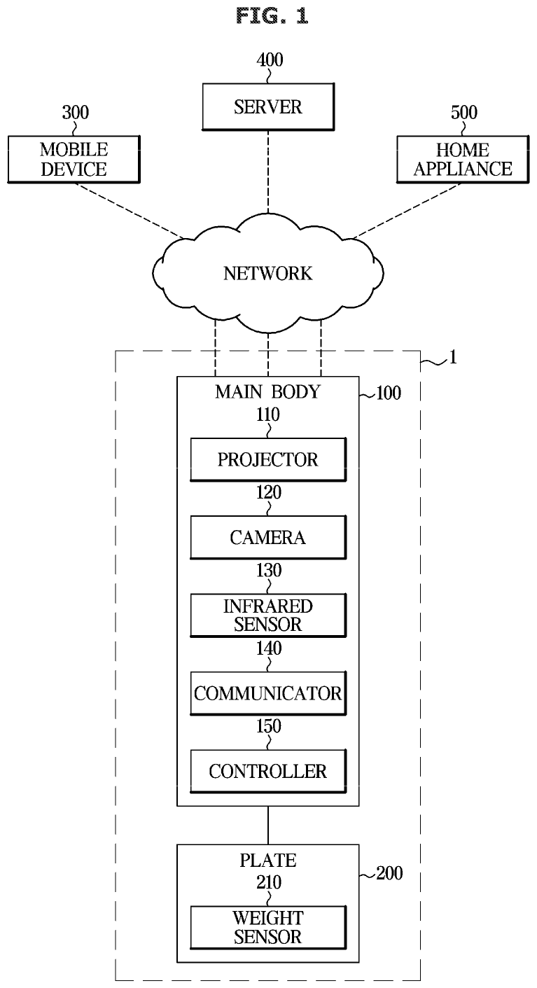

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Like numerals refer to like elements throughout the specification. Not all elements of embodiments of the disclosure will be described, and description of what are commonly known in the art or what overlap each other in the embodiments will be omitted. The term ‘unit, module, member, or block’ may refer to what is implemented in software or hardware, and a plurality of units, modules, members, or blocks may be integrated in one component or the unit, module, member, or block may include a plurality of components, depending on the embodiment of the disclosure.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

Throughout the specification, when it is said that a member is located “on” another member, it implies not only that the member is located adjacent to the other member but also that a third member exists between the two members.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are just used for convenience of explanation, but not to limit an order of the steps. Thus, unless the context clearly dictates otherwise, the written order may be practiced otherwise.

Reference will now be made in detail to embodiments of the disclosure, which are illustrated in the accompanying drawings.

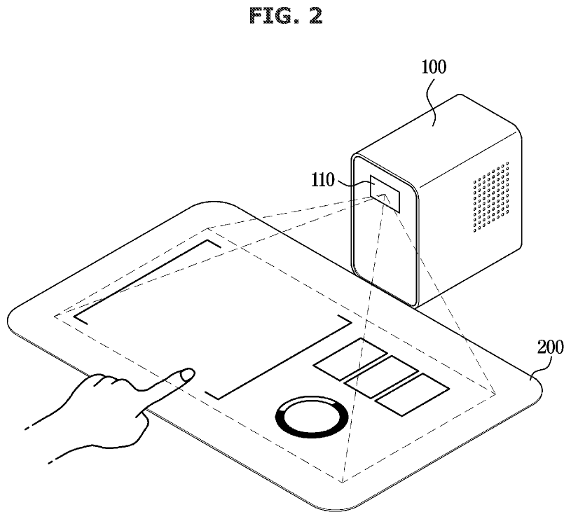

FIG. 1 illustrates system in which a video display device is implemented, according to an embodiment of the disclosure, and FIG. 2 illustrates a video display device, according to an embodiment of the disclosure.

Referring to FIG. 1, a system in which a video display device 1 is implemented includes the video display device 1 including a main body 100 and a plate 200, a mobile device 300, a server 400 and a home appliance 500.

The main body 100 includes a projector 110 for projecting an image onto the plate 200, a camera 120 or an infrared sensor 130 for recognizing a food ingredient placed on the plate 200, and a communicator 140 for communicating with a network and receiving data from the plate 200.

The projector 110 is equipped in the main body 100 to project an image including various information onto a surface of the plate 200. As shown in FIG. 2, the projector 110 is arranged on the front surface of the main body 100 to emit light toward the plate 200 so that an image may not be blocked by a hand of the user.

The projector 110 may receive certain information from the mobile device 300, the server 400, and the home appliance 500 over the network, and project an image based on the received information onto the plate 200.

The projector 110 may project the image onto the plate 200 to output a program stored in a memory (not shown) under the control of a controller 150. Furthermore, the projector 110 may project an image onto the plate 200 based on a user input to output information according to the user input.

The projector 110 outputs cooking information relating to the food ingredient in the image, when the controller 150 recognizes the food ingredient placed on the plate 200 through the camera 120. The cooking information includes at least one of weight information of the food ingredient, calorie information of the food ingredient, a cooking list using the food ingredient, or information about a daily recommended amount of the food recommendation.

The camera 120 obtains image data by capturing the food ingredient placed on the plate 200 and an input (gesture) of the user over the plate 200, and provides the image data to the controller 150. The controller 150 may recognize the food ingredient placed on the plate 200 through the camera 120 and control the projector 110 to output information about the food ingredient onto the plate 200. Furthermore, the controller 150 may recognize the input of the user over the plate 200 through the camera 120 and control the projector 110 to output a response to the input of the user onto the plate 200.

The infrared sensor 130 may be equipped in the main body 100 in addition to the camera 120 to detect a touch input of the user on the plate 200. Specifically, the infrared sensor 130 may recognize a touched point when the user touches a point on the plate 200 onto which an image is projected, so that the controller 150 may control the projector 110 to output information according to the user input.

The communicator 140 may perform call setup and data communication with a base station (BS) over a cellular network such as third generation (3G)/fourth generation (4G)/fifth generation 5G, and transmit or receive data to or from the mobile device 300, the server 400 and the home appliance 500. Furthermore, the communicator 140 may perform a function for short-range communication such as Bluetooth or near field communication (NFC), receive data to obtain weight information from the plate 200, and receive certain information from the mobile device 300 and the home appliance 500, allowing the projector 110 to output them in an image.

The communicator 140 may transmit a cooking command corresponding to an input of the user on or over the plate 200 to the home appliance 500 when the input of the user is recognized through the camera 120 or the infrared sensor 130. Moreover, the communicator 140 may transmit a cooking value based on a recipe to the home appliance in response to detection of a user input selecting a recipe based on the food ingredient. In this case, the cooking value based on the recipe corresponds to data received by the video display device 1 through the server 400 and stored in the memory.

The controller 150 may control the projector 110 to display various information on the plate 200 by executing a program stored in the memory. Furthermore, the controller 150 may reflect various information received from the mobile device 300, the server 400, and the home appliance 500 on a program stored in the memory and control the projector 110 to output an image corresponding to a user input.

The controller 150 may receive an image of the food ingredient from the projector 110 or the mobile device 300 and analyze the received image of the food ingredient to identify a name, a type and a weight of the food ingredient.

The controller 150 may control the projector 110 to display a cooking list and a recipe that may use the food ingredient when the type of the food ingredient placed on the surface of the plate 200 is recognized. Furthermore, the controller 150 may control the projector 110 to display a cooking list that may use a combination of a plurality of food ingredients when the plurality of food ingredients on the surface of the plate 200 are recognized. Moreover, the controller 150 may control the projector 110 to output a recipe corresponding to a cooking list in response to an input of the user.

The controller 150 may include at least one memory for storing a program for carrying out the following operations, and at least one processor (not shown) for executing the program. In a case that the memory and the processor are each provided in the plural, the memory and the processor may be integrated in a single chip or physically distributed.

The plate 200 provides a surface to reflect light irradiated from the projector 110. In other words, the plate 200 may provide a surface to reflect an image produced by the projector 110 and provide various information for the user in the image projected onto the surface.

A food ingredient may be placed in at least a portion of the plate 200, and the plate 200 may be divided by the projector 110 to display various information.

Although the plate 200 is shown in FIG. 2 as including the form of a rectangle, the plate 200 is not limited thereto and the plate 200 may be manufactured in other various forms.

The plate 200 may include a weight sensor 210 to detect a weight of a food ingredient placed on the plate 200, and send the weight information to the controller 150.

The mobile device 300 may be connected with the video display device 1 to obtain cooking information regarding a certain food ingredient, recipe information regarding a plurality of food ingredients, or the like and provide the obtained information to the video display device 1. Furthermore, the mobile device 300 may download a program to be executed by the video display device 1 from the server 400 and provide the program to the video display device 1, and send a command to update the program to the video display device 1.

The mobile device 300 may output information about a food ingredient obtained by the camera 120 and output the information regarding the food ingredient on the screen of the mobile device 300. In this case, the mobile device 300 may output the information about the food ingredient through the same interface as the image displayed on the plate 200, and output the information about the food ingredient through an interface implemented in an application installed on the mobile device 300.

The server 400 may provide at least one of information about the food ingredient placed on the plate 200, a recommended food list, or information about cooking of the food ingredient to the mobile device 300. The server 400 may receive an image of the food ingredient from the main body 100 or the mobile device 300 and analyze the received image of the food ingredient to identify a name, a type and a weight of the food ingredient. Furthermore, the server 400 may receive user information from the mobile device 300 and recommend a certain food based on the user information and information about the food ingredient. Moreover, the server 400 may provide information about food ingredients required for cooking a food and information about detailed cooking stages for cooking the food to the mobile device 300.

The home appliance 500 may refer to any electronic device accessible by the user and capable of storing or cooking food ingredients of a food. For example, the home appliance 500 may include a refrigerator, a gas stove, an oven, an electric burner, a water purifier, a aerated water maker, a blender, a coffee machine, etc. The home appliance 500 may be equipped with Bluetooth or NFC to transmit or receive data to or from the video display device 1.

Features of the video display device 1 according to the disclosure and features of a system in which the video display device 1 is implemented will now be described. Respective steps of controlling performed by the video display device 1 will now be described in detail.

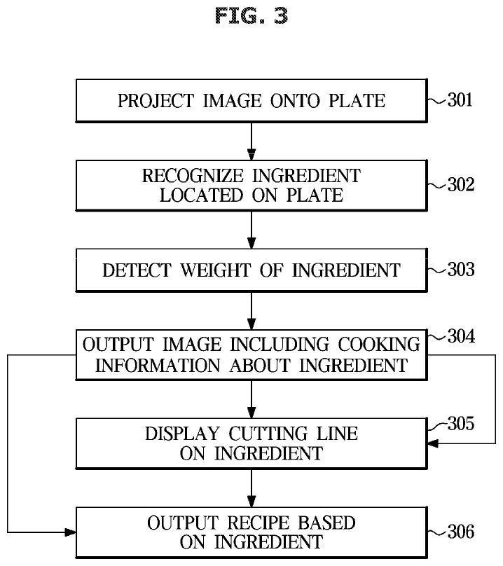

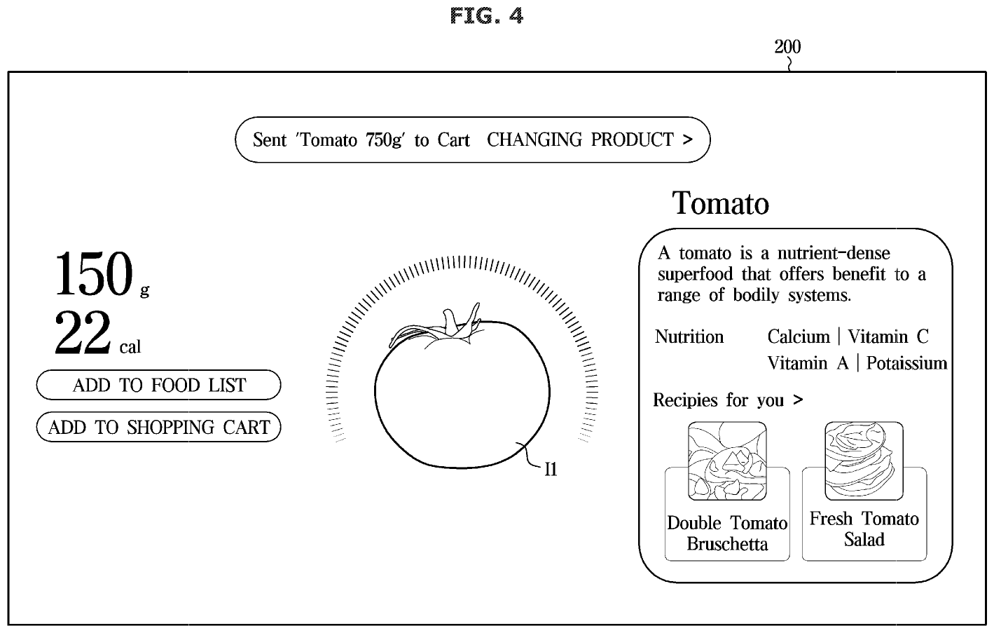

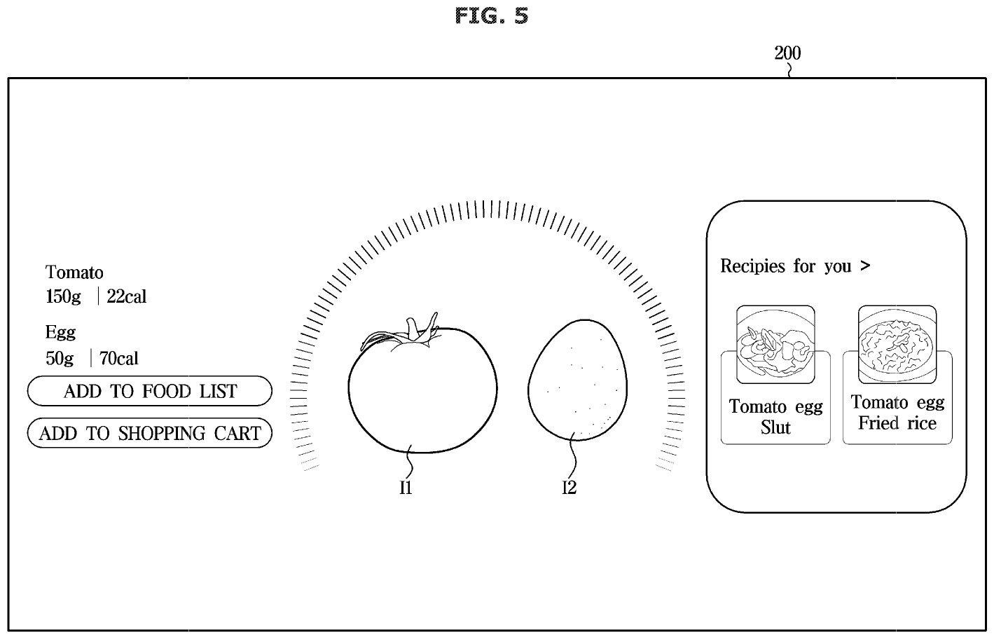

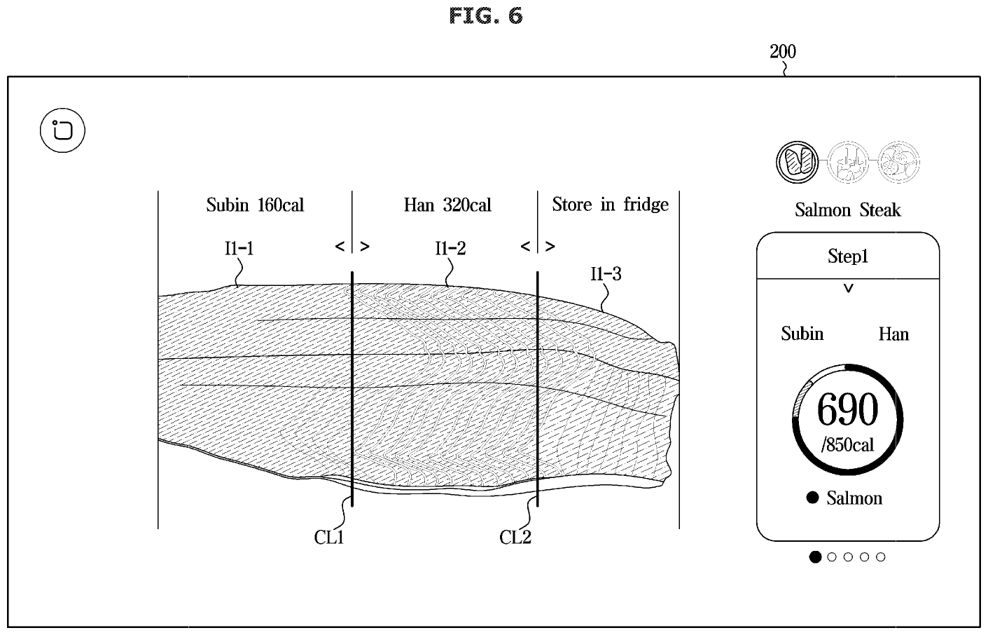

FIG. 3 illustrates a method of controlling a video display device, according to an embodiment of the disclosure. FIG. 4 illustrates an image output by a video display device based on a food ingredient placed on a plate, according to an embodiment, FIG. 5 illustrates an image output by a video display device based on a plurality of food ingredients placed on a plate, according to an embodiment, and FIG. 6 illustrates an image with cutting lines created by a video display device on a food ingredient placed on a plate, according to an embodiment. The control method of FIG. 3 will be described by referring to FIGS. 4 to 6.

The controller 150 controls the projector 301 to project an image onto the plate 200, in 301. The image projected onto the plate 200 may include an interface implemented in an application installed on the mobile device 300, or an interface implemented in an application installed on the video display device 1 itself.

The controller 150 recognizes a food ingredient placed on the plate 200 through the camera 120, in 302. Referring to FIG. 4, the controller 150 controls the projector 110 to output the weight information of a food ingredient I1 and calorie information of the food ingredient when the food ingredient I1 placed on the plate 200 is recognized. In this case, the controller 150 may obtain the weight information by detecting a weight of the food ingredient I1 through the weight sensor 210 arranged in the plate 200 or obtain the weight information in consideration of a type of the food ingredient and volume of the food ingredient by obtaining the image data through the camera 120.

The controller 150 outputs an image including cooking information regarding the food ingredient, in 304. Specifically, the controller 150 may figure out the type of the food ingredient I1 by obtaining the image data through the camera 120, and control the projector 110 to output recipe information for a food that uses the food ingredient I1 based on the weight information.

Furthermore, in an embodiment, the controller 150 may simultaneously output pieces of information about a plurality of food ingredients I1 and I2 when the plurality of food ingredients I1 and I2 placed on the plate 200 are recognized. Referring to FIG. 5, the controller 150 may obtain individual weight information by detecting the plurality of food ingredients I1 and I2 on the plate 200 with a certain time gap. For example, when detecting the second food ingredient I2, e.g., an egg, after detecting the first food ingredient I1, e.g., a tomato, the controller 150 may obtain the weight information of the second food ingredient I2, the egg, by subtracting the weight of the first food ingredient I1, the tomato, from a total weight. Once obtaining the weight information of each of the plurality of food ingredients I1 and I2, the controller 150 controls the projector 110 to output the calorie information onto the plate 200 based on the type and weight information of the food ingredients. The controller 150 may also provide information about types and recipes of foods that may be made with the plurality of food ingredients I1 and I2.

Furthermore, the controller 150 may control the projector 110 to provide a cutting line on a food ingredient that needs to be subdivided.

Referring to FIG. 6, the controller 150 may recognize a type of the food ingredient placed on the plate 200 and provide cutting lines CL1 and CL2 based on user information, calorie information, and a daily recommended amount. For example, the controller 150 may recognize that the food ingredient placed on the plate 200 is a salmon, and provide the cutting lines CL1 and CL2 based on the calorie information of the salmon. Furthermore, the controller 150 may display the cutting lines on the surface of the salmon for the user who intends to have the food to be able to cut the salmon according to the daily recommended amount when the user inputs multiple pieces of user information (e.g., age, sex, weight, etc.). In FIG. 6, the first cutting line CL1 and the second cutting line CL2 are shown to provide daily recommended amounts for the first user and the second user, respectively. Furthermore, the controller 150 may obtain weight information of a portion of the food ingredient left by the second cutting line CL2 and transmit the weight information to a home appliance (e.g., a refrigerator) connected with the video display device 1.

The controller 150 may output a recipe based on the food ingredient placed on the plate 200, in 306. The recipe may be provided according to data provided from the server 400 or stored in a memory (not shown), and provided in voice instructions or in video.

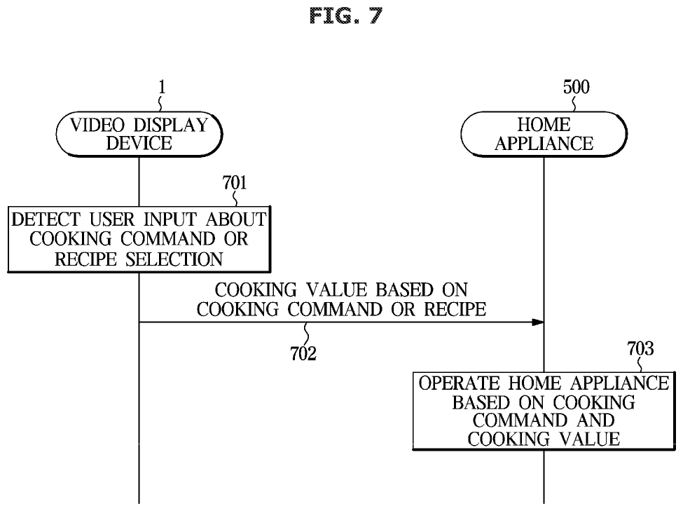

FIG. 7 illustrates a control sequence chart between a video display device and a home appliance, according to an embodiment.

In an embodiment, the video display device 1 may transmit a cooking command to at least one home appliance 500 to operate the home appliance 500. For example, in the embodiment, the home appliance 500 may be one of a gas stove, a microwave, an oven and an electric burner, and the user may control the home appliance 500 to operate the home appliance 500 through an input to the video display device 1 without inputting the cooking command directly to the home appliance 500.

The video display device 1 detects an input of the user about a cooking command or a selection of recipe, in 701. For example, the video display device 1 may control the projector 110 to display an interface of an input module (not shown) of the home appliance 500 connected with the video display device 1 on the plate 200.

In this case, the user may make a touch input to the interface displayed on the plate 200 to transmit a cooking command to the home appliance 500. Furthermore, the user may make a touch input to the interface displayed on the plate 200 to transmit a recipe-based cooking value to the home appliance 500.

The video display device 1 may control the communicator 140 to transmit the cooking command or the recipe-based cooking value input from the user to the home appliance 500, in 702.

On receiving the cooking command or the recipe-based cooking value from the video display device 1, the home appliance 500 may be operated based on the cooking command or the cooking value. For example, in a case that the home appliance 500 is a microwave, when the user inputs an operation period of time of the microwave through the interface displayed on the plate 200, put a food ingredient into the microwave and close the door, the microwave may be automatically operated without extra button input.

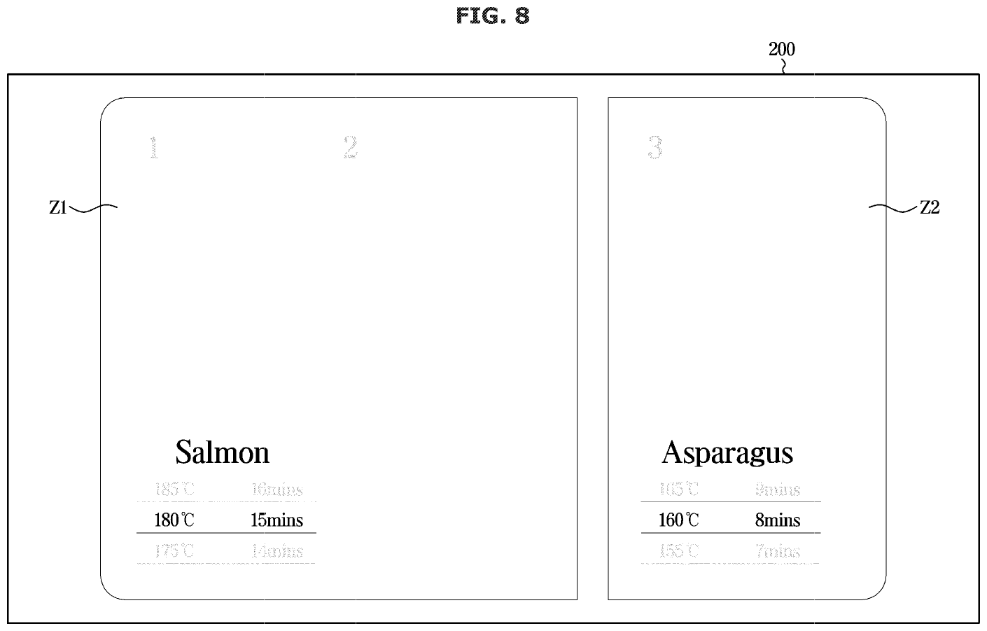

Referring to FIG. 8, the video display device 1 may transmit a cooking command for each of the plurality of zones Z1 and Z2 to an oven capable of multi-zone cooking. Specifically, the video display device 1 may control the projector 110 to display an interior image of an actual oven on the plate 200 so that different food ingredients may be divided into a first zone Z1 and a second zone Z2.

In an embodiment, when the user places salmon in the first zone Z1 and asparagus in the second zone Z2, the controller 150 may display temperature and heating time suitable for cooking the salmon in the first zone Z1 and display temperature and heating time suitable for cooking the asparagus in the second zone Z2. In this case, the temperature and heating time displayed in the first zone Z1 and the second zone Z2 may be automatically displayed based on the video display device 1 recognizing the food ingredients through the camera 120. Furthermore, cooking values including the temperature and heating time may be automatically displayed based on the recognition of the food ingredients as described above, or may be input by the user in person to transmit the cooking command to the oven.

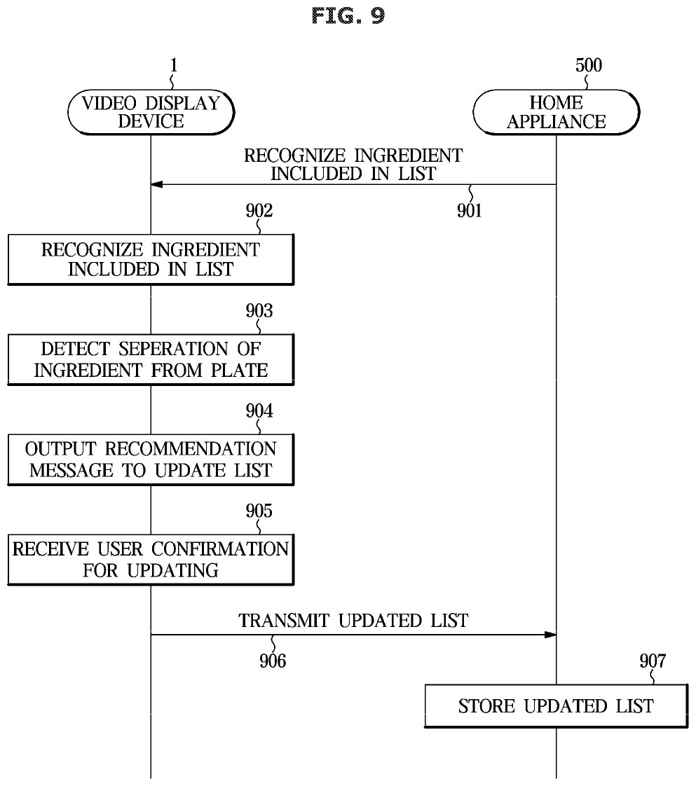

FIG. 9 illustrates a control sequence chart between a video display device and a home appliance, according to an embodiment. In the embodiment, the home appliance 500 may be a refrigerator for storing food ingredients, or may be other various devices equipped with a memory to store information about food ingredients stored in the home appliance 500.

The embodiment of FIG. 9 will now be described in detail in connection with FIG. 6.

The home appliance 500 transmits a list of food ingredients stored therein to the video display device 1, in 901. The list is information including names, amounts, expiration dates, etc., of various food ingredients stored in the home appliance 500. The video display device 1 capable of performing wireless communication with the home appliance 500 may request a list of food ingredients stored in the home appliance 500 from the home appliance 500 and receive information about the food ingredients stored in the home appliance 500. Furthermore, the video display device 1 may receive information stored in the home appliance 500 in real time according to an automatic reception setting.

When the user inputs information about food ingredients through an input device (not shown) included in the home appliance 500, the home appliance 500 may add the food ingredient information to the list and stored the list. Furthermore, the home appliance 500 may generate a list of food ingredients stored, through a camera included in the home appliance 500.

The video display device 1 detects food ingredients on the plate 200 and recognizes the food ingredients included in the list, in 902. In this case, the video display device 1 may obtain detailed information (e.g., an amount or an expiration date) of a food ingredient based on the list received from the home appliance 500 and the type of the food ingredient obtained through the camera 120. Furthermore, the video display device 1 may recognize a food ingredient taken out from inside the home appliance 500 and receive detailed information about the recognized food ingredient.

As shown in FIG. 6, the user may cook the food ingredient taken out from the home appliance 500 on the plate 200 and subdivide the food ingredient according to the cutting line CL provided by the video display device 1.

The video display device 903 detects separation of the food ingredient from the plate, in 903. The video display device 1 may figure out an amount of the rest of the food ingredient other than the portion of the food ingredient separated according to the cutting line. Specifically, the video display device 903 may figure out the weight of the rest of the food ingredient by subtracting the weight of the portion of the food ingredient to be cooked by the user from the weight included in the list. For example, referring to FIG. 6, the video display device 1 may figure out the weight of the rest of the food ingredient I1-3 separated according to the second cutting line CL2.

When the weight of the rest of the food ingredient is figured out, the video display device 1 outputs a recommendation message for updating the list with the remaining food ingredient, in 904. For example, once the subdivision of the food ingredient placed on the plate 200 is completed, the video display device 1 may control the projector 110 to output a recommendation message “Will you update the list with the remaining salmon? yes or no” onto the plate 200. In this case, the user may select “yes” to store the remaining food ingredient in the refrigerator. Furthermore, the user may select “no” to discard the remaining food ingredient.

When receiving confirmation of the user about the updating from the user in 905, the video display device 1 transmits an updated list in 906. In another embodiment, the video display device 1 may not provide the recommendation message in 904 but may automatically transmit the updated list. In addition, when the expiration date of the food ingredient is not expired, the video display device 1 may not provide the recommendation message in 904 but may automatically transmit the updated list.

The home appliance 907 receives the updated list from the video display device 1 and stores the updated list in 907.

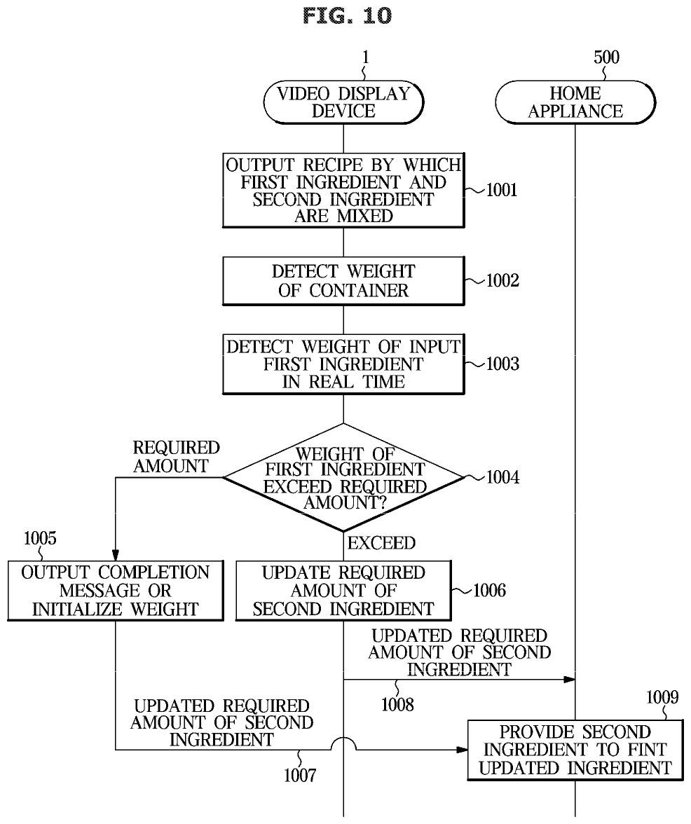

In the meantime, the video display device 1 may provide a recipe of a food made by mixing two or more food ingredients. For example, the video display device 1 may sequentially provide processes of the recipe of a drink made by mixing a concentrate and water (or aerated water), dough made by mixing flour and water, etc. In addition, the video display device 1 may provide a guide by reflecting amounts of input food ingredients, in preparation for a failure of ratio control when the two or more food ingredients are mixed. This will now be described in connection with FIGS. 10 to 13. Embodiments as will be described below are merely examples, and may be applied to various foods made by mixing at least two or more food ingredients.

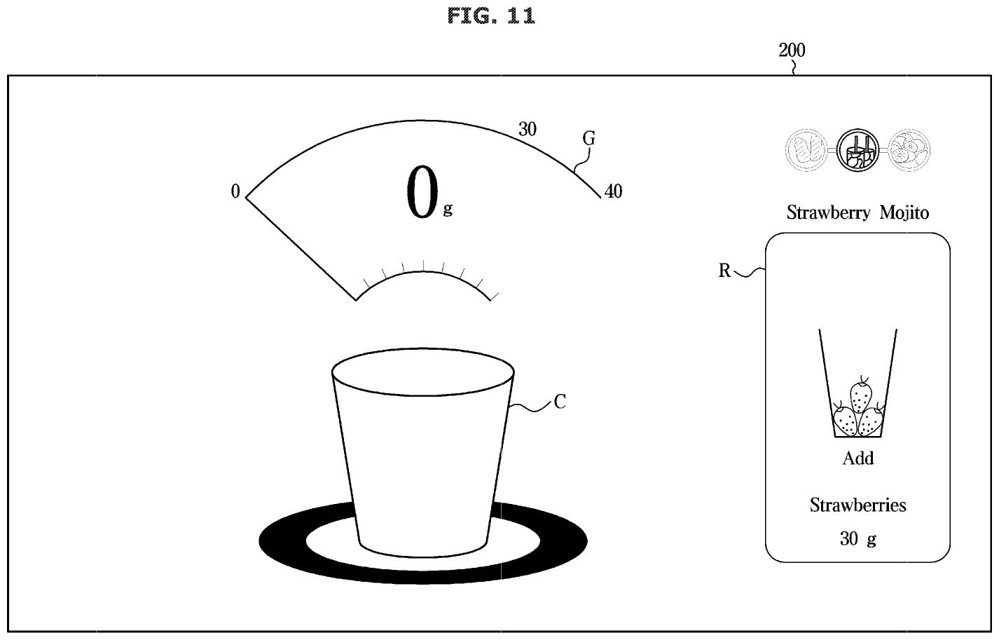

FIG. 10 illustrates a control sequence chart between a video display device and a home appliance, according to another embodiment, and FIGS. 11 to 13 are diagrams to be referred to in describing the control sequence chart of FIG. 10.

The video display device 1 outputs a recipe by which a first food ingredient and a second food ingredient are mixed, in 101. For example, when the user selects the number of consumers and a food type, the video display device 1 may output a corresponding recipe. In this case, the recipe may include amount information and a making sequence about the food ingredients including the concentrate and the aerated water to make a strawberry soda.

The video display device 1 detects a weight of an empty container when the user puts the empty container on the plate 200, in 1002. Accordingly, the video display device 1 may perform zero-point adjustment to detect the weight of a pure food ingredient by detecting the weight of the container through the weight sensor 210 equipped in the plate 200. Referring to FIG. 11, when the user puts a container for making a strawberry soda on the plate 200 the video display device 1 may control the projector 110 to check that the current weight has been subjected to zero-point adjustment into 0 gram (g). When the zero-point adjustment is completed, the video display device 1 may control the projector 110 to display a required amount of the first food ingredient that the user needs to input.

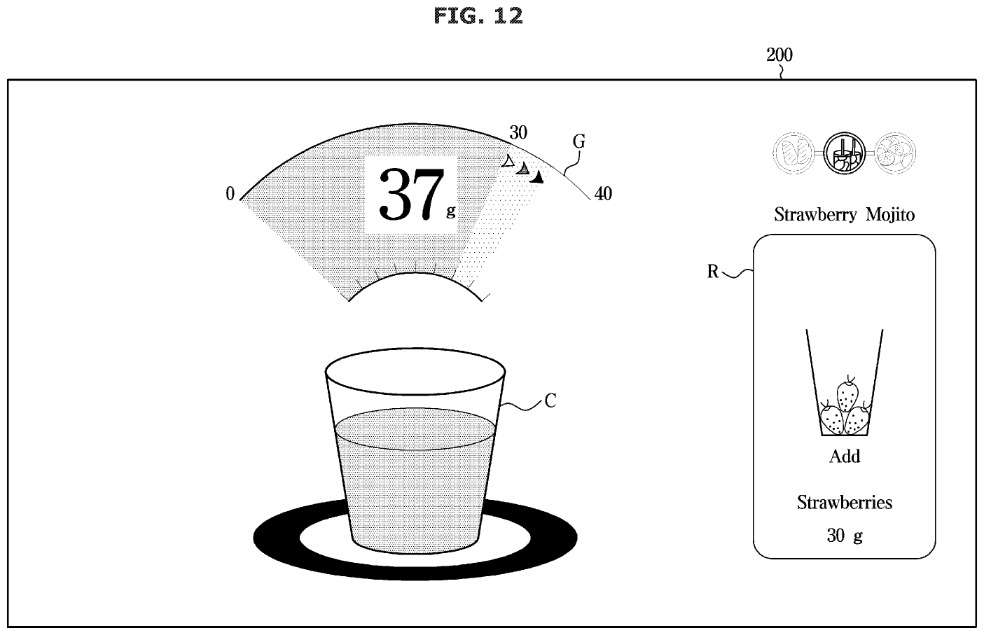

The video display device 1 detects the weight of the input first food ingredient in real time, in 1003. For example, referring to FIG. 12, the video display device 1 displays the weight of the first food ingredient input by the user on the plate 210. However, as shown in FIG. 12, according to recipe information R displayed on the right-hand side, when the required amount of the first food ingredient is 30 g, the user may not perform optimal cooking with the required amount of the second food ingredient suggested earlier. Hence, the video display device 1 according to the embodiment may provide a required amount of the second food ingredient corresponding to the changed first food ingredient.

The video display device 1 determines whether the weight of the first food ingredient exceeds the required amount, in 1004. In this case, when the inputting of the first food ingredient is completed or exceeds the required amount, the video display device 1 may output a message in sound or display.

When the video display device 1 determines that the weight of the first food ingredient put in the container corresponds to the required amount, the video display device 1 may output a completion message or make weight initialization to identify the weight of the second food ingredient before inputting of the second food ingredient, in 1005. Accordingly, the user may input the second food ingredient into the container to fit the required amount of the second food ingredient.

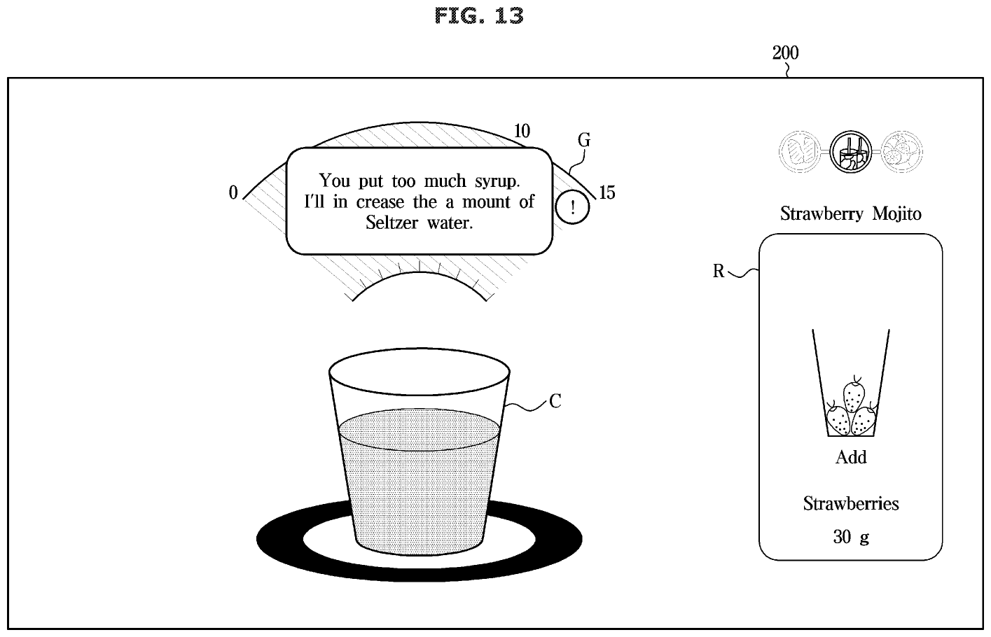

On the other hand, when the weight of the first food ingredient put in the container exceeds the required amount, the video display device 1 updates a required amount of the second food ingredient, in 1006. Specifically, the video display device 1 controls the projector 110 to display an amount of the second food ingredient changed to maintain the ratio between the first food ingredient and the second food ingredient suggested earlier. Referring to FIG. 13, the video display device 1 may provide a message to increase an input amount of the aerated water as the user exceedingly inputs the first food ingredient. Accordingly, the user may input the second food ingredient to the container to fit the changed required amount of the second food ingredient.

As described above, the user may input the second food ingredient in person according to a guide suggested by the video display device 1. Furthermore, according to the embodiment, the video display device 1 transmits a required amount of the second food ingredient to the home appliance 500 that provides the second food ingredient, so that the user may not control the amount of the second food ingredient in person. In this example, the home appliance 500 that receives data from the video display device 1 may be e.g., a water purifier or an aerated water maker.

The home appliance 500 may receive the existing required amount of the second food ingredient in 1007 or receive an updated required amount of the second food ingredient in 1008. In this case, the home appliance 1009 may provide the second food ingredient based on the received required amount without a need for the user to control the amount through the home appliance 1009. For example, the aerated water maker may provide aerated water that fits the received required amount when detecting an input from the user to release water.

Meanwhile, the embodiments of the disclosure may be implemented in the form of a recording medium for storing instructions to be carried out by a computer. The instructions may be stored in the form of program codes, and when executed by a processor, may generate program modules to perform operation in the embodiments of the disclosure. The recording media may correspond to computer-readable recording media.

The computer-readable recording medium includes any type of recording medium having data stored thereon that may be thereafter read by a computer. For example, it may be a read only memory (ROM), a random access memory (RAM), a magnetic tape, a magnetic disk, a flash memory, an optical data storage device, etc.

The machine-readable storage medium may be provided in the form of a non-transitory recording medium. The term ‘non-transitory recording medium’ may mean a tangible device without including a signal, e.g., electromagnetic waves, and may not distinguish between storing data in the recording medium semi-permanently and temporarily. For example, the non-transitory recording medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play Store™) directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

The embodiments of the disclosure have thus far been described with reference to accompanying drawings. The disclosure may be practiced in other forms than the embodiments of the disclosure as described above without changing the technical idea or essential features of the disclosure. The above embodiments of the disclosure are only by way of example, and should not be construed in a limited sense.

Although the present disclosure has been described with various embodiments, various changes and modifications may be suggested to one skilled in the art. It is intended that the present disclosure encompass such changes and modifications as fall within the scope of the appended claims.

What is claimed is:

1. A video display device comprising:
a plate configured to detect a weight of a food ingredient;
a projector configured to project an image onto the plate;
a camera configured to capture an input of a user relative to the image projected, and the food ingredient; and
a controller configured to change the image and control the projector to project the image changed, in response to a weight change of the food ingredient or the input of the user.

2. The video display device of claim 1, wherein the controller is configured to recognize the food ingredient located on the plate through the camera, and control the projector to project the image changed to include cooking information regarding the food ingredient.

3. The video display device of claim 2, wherein the controller is configured to control a main body to output the image changed to include the cooking information including weight information of the food ingredient, calorie information of the food ingredient, a cooking list using the food ingredient, and information about a recommended amount of the food ingredient.

4. The video display device of claim 2, wherein the controller is configured to control the projector to project a recipe based on a plurality of food ingredients in the image, in response to recognition of the plurality of food ingredients on a surface of the plate.

5. The video display device of claim 1, wherein the controller is configured to control the projector to project a cutting line to be displayed on the food ingredient located on the plate, wherein the cutting line is generated based on at least one of weight information, calorie information, or information about a recommended amount of the food ingredient.

6. The video display device of claim 1, further comprising: a communicator configured to communicate with at least one of a server or a home appliance.

7. The video display device of claim 6, wherein the controller is configured to control the communicator to transmit a cooking command to the home appliance in response to detection of a user input about the cooking command.

8. The video display device of claim 6, wherein the controller is configured to control the communicator to transmit a cooking value based on a recipe to the home appliance, in response to detection of a user input selecting the recipe based on the food ingredient.

9. The video display device of claim 6, wherein:
the communicator is configured to control the home appliance to update a list registered in the home appliance with a portion of the food ingredient, in response to separation of the food ingredient from the plate; and
the home appliance is a refrigerator.

10. The video display device of claim 6, wherein the controller is configured to control a main body to output a message confirming or rejecting updating in the image based on separation of the food ingredient from the plate.

11. The video display device of claim 6, wherein the controller is configured to:
control a main body to output the image changed to include a plurality of zones for which different cooking is performed by a home appliance, and
control the communicator to receive an input of the user determining a cooking value for each of the plurality of zones, and
transmit the cooking value for each of the plurality of zones to the home appliance, wherein the home appliance is an oven capable of multi-zone cooking.

12. The video display device of claim 1, wherein the controller is configured to control a main body to:
output a recipe for each stage of cooking which mixes a plurality of food ingredients in the image;
output a weight of a first food ingredient in real time based on input of the first food ingredient to a container for performing the stage of cooking, the first food ingredient among the plurality of food ingredients; and
output a message based on completion of the inputting of the first food ingredient, wherein the message is output visually for display or output as sound.

13. The video display device of claim 12, wherein the controller is configured to initialize an output weight in response to completion of the inputting of the first food ingredient.

14. The video display device of claim 12, wherein the controller is configured to update a required amount of a second food ingredient to maintain a ratio of the second food ingredient to the first food ingredient set in the recipe, in response to the inputted amount of the first food ingredient exceeding a required amount of the first food ingredient.

15. The video display device of claim 12, wherein:
the main body further comprises a communicator configured to communicate with at least one of a server or a home appliance;
the controller is configured to transmit, to the home appliance, a required amount of a second food ingredient corresponding to a ratio of the second food ingredient to the first food ingredient set in the recipe, in response to completion of inputting of the first food ingredient; and
the home appliance comprises a water purifier or an aerated water maker.

16. A method comprising:
detecting a weight of a food ingredient, the food ingredient located on a plate;
projecting, by a projector, an image onto the plate;
capturing, by a camera, an input of a user relative to the image projected, and the food ingredient; and
in response to a weight change of the food ingredient or the input of the user:
changing, by a controller, the image; and
projecting, by the projector, the image changed.

17. The method of claim 16, further comprising:
controlling a main body to output a recipe for each stage of cooking which mixes a plurality of food ingredients in the image;
outputting a weight of a first food ingredient in real time, based on input of the first food ingredient to a container,
wherein the container is for performing the stage of cooking, and
wherein the first food ingredient is from among the plurality of food ingredients; and
outputting, visually for display or as a sound, a message based on completion of the inputting of the first food ingredient into the container.

18. The method of claim 17, further comprising initializing an output weight in response to completion of the inputting of the first food ingredient into the container.

19. The method of claim 17, further comprising in response to the inputted amount of the first food ingredient exceeding a required amount of the first food ingredient, updating a required amount of a second food ingredient to maintain a ratio of the second food ingredient to the first food ingredient set in the recipe.

20. The method of claim 17, further comprising in response to completion of inputting of the first food ingredient into the container, transmitting, to a home appliance, a required amount of a second food ingredient corresponding to a ratio of the second food ingredient to the first food ingredient set in the recipe,
wherein the main body further comprises a communicator configured to communicate with at least one of a server or the home appliance, and
wherein the home appliance comprises a water purifier or an aerated water maker.
